(19) United States
(12) Patent Application Publication
(10) Pub. No.: US 2024/0221403 A1
(43) Pub. Date: Jul. 4, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: KOHEI TODA, Kanagawa (JP); SATORU YAMANAKA, Kanagawa (JP)

(21) Appl. No.: 18/402,374

(22) Filed: Jan. 2, 2024

(30) Foreign Application Priority Data
Jan. 4, 2023 (JP) 2023-000179

(51) Int. Cl. G06V 30/10; G06T 3/40; G06V 30/414

(52) U.S. Cl. CPC G06V 30/10; G06T 3/40; G06V 30/414

(57) ABSTRACT

An apparatus includes: an obtainment unit configured to obtain a document image at least including first character images and second character images, the first character images being ordinary character images appropriate for character recognition processing, the second character images having a different height-width ratio from a height-width ratio of the ordinary character images and having a greater size than a size of the ordinary character images; an enlargement unit configured to enlarge a target text line region including the second character images such that the height-width ratio of each of the second character images included in the target text line region is equal to the height-width ratio of the first character images; and a character recognition unit configured to perform character recognition processing on the target text line region enlarged by the enlargement unit.

### BACKGROUND

### Field

The present disclosure relates to processing to recognize a character in an image.

### Description of the Related Art

There is a method of recognizing a character in a document image by performing optical character recognition (OCR) processing on the document image obtained by scanning or image-capturing a document. Additionally, there is a method of performing predetermined processing on the document image before the OCR processing in order to enhance the accuracy of the recognition of the character in the document image.

Japanese Patent Laid-Open No. 2019-159633 describes a method of enhancing the accuracy of character recognition of a second characters by performing conversion processing to make the size of the second characters, which is a different size from a reference size, close to the reference size and performing character recognition processing on an image of the character after the conversion processing.

In the method in Japanese Patent Laid-Open No. 2019-159633, in a case where the size of the second characters is greater than the reference size, it is necessary to compress the size of the second characters to be close to the reference size. However, the compression may damage information on the character in some cases. Therefore, there is a possibility that the accuracy of the character recognition of the second characters cannot be enhanced.

### SUMMARY

An image processing apparatus of the present disclosure includes: an obtainment unit configured to obtain a document image at least including first character images and second character images, the first character images being ordinary character images appropriate for character recognition processing, the second character images having a different height-width ratio from a height-width ratio of the ordinary character images and having a greater size than a size of the ordinary character images; an enlargement unit configured to enlarge a target text line region including the second character images such that the height-width ratio of each of the second character images included in the target text line region is equal to the height-width ratio of the first character images; and a character recognition unit configured to perform character recognition processing on the target text line region enlarged by the enlargement unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information processing system;

FIG. 2 is a diagram illustrating an example of a functional configuration of an information processing apparatus;

FIG. 3 is a diagram illustrating an example of a document that is a target of character recognition processing;

FIG. 4 is a flowchart describing a flow of OCR processing;

FIG. 5 is a flowchart describing details of character attribute determination processing;

FIG. 6 is a flowchart describing details of text line attribute determination processing;

FIG. 7 is a flowchart describing details of the text line attribute determination processing;

FIGS. 8A through 8C are diagrams describing deformation of a text line region with a text line attribute of double height;

FIGS. 9A through 9C are diagrams describing deformation of the text line region with the text line attribute of character size-mixed text line; and

FIG. 10 is a flowchart describing a flow of the OCR processing.

### DESCRIPTION OF THE EMBODIMENTS

Embodiments of a technique of the present disclosure are described below with reference to the drawings. Note that, the following embodiments are not intended to limit the technique of the present disclosure, and not all the configurations described in the following embodiments are necessarily required for the means for solving the problems of the present disclosure. The technique of the present disclosure is not limited to the following embodiments, and various deformations and changes are possible within the scope of the gist.

### First Embodiment

### Hardware Configuration

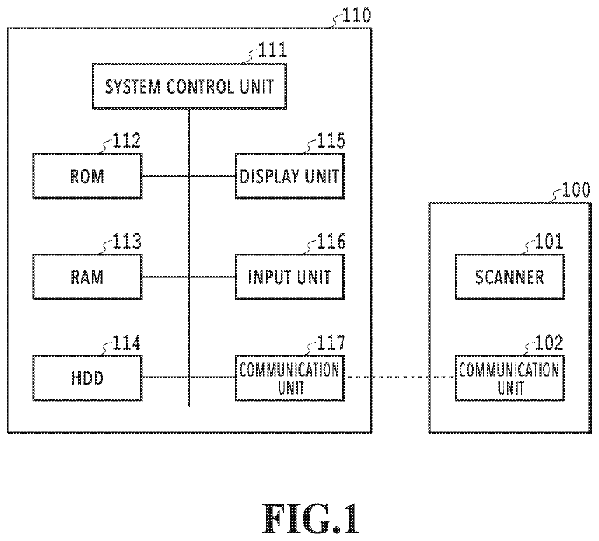

FIG. 1 is a diagram illustrating an information processing system of the present embodiment. The information processing system includes an image formation apparatus 100 and an image processing apparatus 110.

The image formation apparatus 100 is implemented by a multi-function peripheral (MFP) or the like including multiple image formation functions such as printing, scanning, and faxing. The image formation apparatus 100 includes at least a scanner 101 and a communication unit 102.

The scanner 101 optically reads a document printed on a storage medium such as paper, and a document image of a bitmap expressing the contents of the document is generated with a not-illustrated image processing unit of the image formation apparatus 100 performing predetermined image processing. The communication unit 102 of the image formation apparatus 100 transmits the generated document image to the image processing apparatus 110.

The image processing apparatus 110 includes a system control unit 111, a ROM 112, a RAM 113, an HDD 114, a display unit 115, an input unit 116, and a communication unit 117.

For example, the system control unit 111 is a CPU and executes various types of processing by reading a control program stored in the ROM 112. The RAM 113 is used as a main memory of the system control unit 111 and a temporal storage region such as a working area. The HDD 114 stores various data, various programs, and the like.

The communication unit 117 of the image processing apparatus 110 performs communication processing with an external apparatus such as the image formation apparatus 100 through a network. The display unit 115 displays various types of information. The input unit 116 includes a keyboard and a mouse and accepts various operations by a user. Note that, the display unit 115 and the input unit 116 may be provided integrally like a touch panel. Additionally, the display unit 115 may be a unit that performs projection by a projector, and the input unit 116 may be a unit that recognizes a position of a fingertip on the projected image by a camera.

Note that, a hardware configuration in FIG. 1 is an example, and additionally, at least a part of the functions of the display unit 115 and the input unit 116 may be a function of the image formation apparatus 100. At least a part of the configuration of the image processing apparatus 110 may be included in the image formation apparatus 100, and an apparatus integrally including the image formation apparatus 100 and the image processing apparatus 110 may be applied, for example.

### Functional Configuration

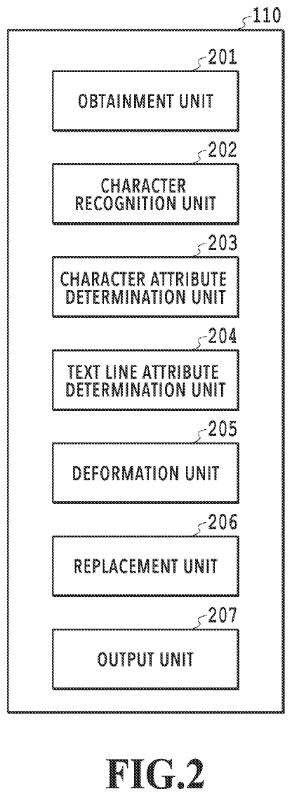

FIG. 2 is a diagram illustrating an example of a functional configuration of the image processing apparatus 110, which is an information processing apparatus of the present embodiment. The image processing apparatus 110 includes an obtainment unit 201, a character recognition unit 202, a character attribute determination unit 203, a text line attribute determination unit 204, a deformation unit 205, a replacement unit 206, and an output unit 207. Functions of those units are described with description of the later-described flowchart.

Each functional unit of the image processing apparatus 110 in FIG. 2 is implemented with the system control unit 111 (the CPU) executing a predetermined program; however, it is not limited thereto. Additionally, for example, hardware such as a graphics processing unit (GPU) that speeds up the computation or a field programmable gate array (FPGA) may be used. Each functional unit may be implemented by cooperation between software and hardware such as a dedicated IC, or a part of or all the functions may be implemented by only hardware.

### About Document Image

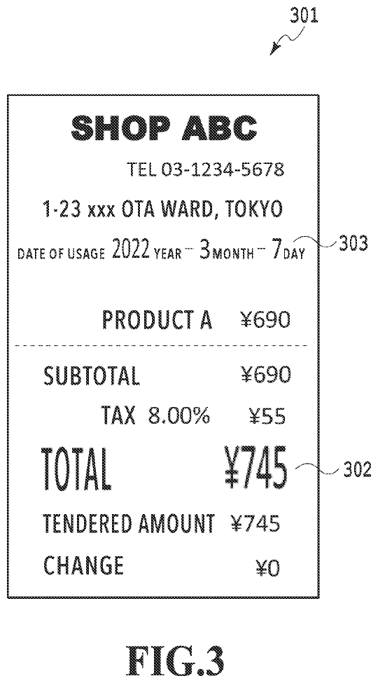

FIG. 3 is a diagram illustrating an image obtained by reading a receipt 301, which is an example of a document image that is a target of character recognition processing. The character recognition processing (also referred to as OCR processing) by the character recognition unit 202 of the image processing apparatus 110 is described with reference to FIG. 3.

A text line 302 in the receipt 301 includes a character that is printed as a double height character, which is long in a direction (referred to as a height direction or a longitudinal direction) orthogonal to a direction in which characters are lined up (referred to as a transverse direction or a width direction) and has a different shape in an aspect ratio (a height-width ratio) from an ordinary character. Since the total price is important information for a purchaser, the characters such as “total” are printed to be emphasized by using the double height character to allow the purchaser to easily find the printed position.

In some cases, not many fonts of the characters are used in printing of the receipt. For this reason, the special character such as the double height character may be used in a character string that is demanded to be expressed in an emphasized manner. The double height character used for the emphasis is often limited to only some of the characters in the document. On the other hand, the character included in the document is usually the ordinary character, which is not the double height character. Therefore, processing of the character recognition processing is performed at the setting that allows for proper recognition of the ordinary character as described above. For this reason, in a case where the double height character is used in a part of the document, if the character recognition processing is performed based on the ordinary character constituting the majority of the document, the double height character may be falsely recognized. To deal with this, in the present embodiment, the false recognition of the special character is suppressed by enlarging a target region including the special character such as the double height character to have the same aspect ratio with the ordinary character and then performing the character recognition processing on the target region after the enlargement.

### Overall Processing Flow of OCR Processing

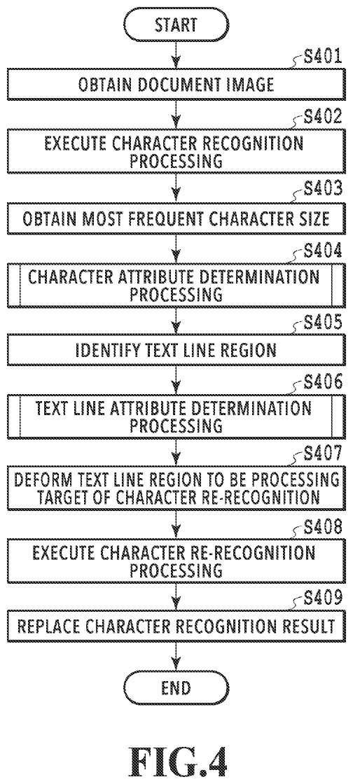

FIG. 4 is a flowchart describing a flow of the OCR processing by the image processing apparatus 110. A series of processing illustrated in the flowchart in FIG. 4 is performed with the system control unit 111 (the CPU) of the image processing apparatus 110 deploying a program code stored in the ROM 112 to the RAM 113 to execute. Additionally, a part of or all the functions of steps in FIG. 4 may be implemented by hardware such as an ASIC or an electronic circuit. Note that, a sign “S” in each description of the processing means that it is a step in the flowchart, and the same applies to the subsequent flowchart.

In the present embodiment, as described above, the document image is generated with the scanner 101 of the image formation apparatus 100 scanning the document of paper such as the receipt. The generated document image is transmitted to the image processing apparatus 110. In the image processing apparatus 110, the document image is stored in the HDD 114. The flowchart in FIG. 4 starts once the document image is stored into the HDD 114.

In S401, the obtainment unit 201 obtains data of the document image from the HDD 114.

In S402, the character recognition unit 202 performs the character recognition processing on the entire document image. In the character recognition processing, a character region is extracted from the document image, and a character code of the character included in the character region is identified to recognize the character. Additionally, the character recognition unit 202 obtains information such as the position and the size of the character region. It is possible to use an already-known character recognition method for the character recognition processing. For example, as the method of identifying the character code in the character region, there has been known a method of using an identification model that has learned to input the character image and to output the character code.

The character recognition unit 202 derives the reliability of the recognized character. For example, the reliability is a value indicating a concordance rate between characteristic amounts of the character obtained as a result of the character recognition processing and a saved default character. A character with a high numerical value of the reliability indicates that it is a reliable result.

In S403, the character attribute determination unit 203 obtains the most frequent value of a size of a character group recognized from the document image. Specifically, the most frequent value (the most frequent character height) of a length of the character group in the longitudinal direction (a character height) and the most frequent value (the most frequent character width) of a length of the character group in the transverse direction (a character width) are obtained. The method of obtaining the most frequent character height and the most frequent character width is, for example, to obtain the size of the character region of the character group obtained in S402 and to obtain the character height with the highest frequency of appearance as the most frequent character height and obtain the character width with the highest frequency of appearance as the most frequent character width. In this process, the most frequent character height and the most frequent character width may be obtained while assuming that a value within a predetermined range is the same character height or the same character width.

In S404, character attribute determination processing is executed. In the character attribute determination processing, a character attribute is determined for each of the character group obtained as a result of the character recognition in S402. Details of the character attribute determination processing are described later.

In S405, based on a pixel value of the document image obtained in S401, the layout of the document image, and the information obtained in S402 and S403, the text line attribute determination unit 204 identifies a text line region lined with the characters in the transverse direction in the document image. For example, the text line 302 in which “total ¥745” is printed is identified as the text line region from FIG. 3.

In S406, text line attribute determination processing is executed. In the text line attribute determination processing, a text line attribute is determined for each text line region identified in S405. Details of the text line attribute determination processing are described later.

In S407, the deformation unit 205 performs deformation processing on a predetermined text line attribute from the text line regions identified in S405, in accordance with the text line attribute on the text line region. As a result, an image of the text line region that is deformed such that the character in the text line region identified in S405 is properly character-recognized is generated. With this, an image to be a target of character re-recognition executed in the next S408 is obtained. Details of the processing to generate the image of the text line region that is the character re-recognition target are described later.

In S408, the character recognition unit 202 performs the character recognition processing on the image of the text line region that is the character re-recognition target deformed by the deformation unit 205. The character recognition processing in the present step may be referred to as the character re-recognition. The method of the character re-recognition is similar to the character recognition processing in S402, and as a result of the character re-recognition, the character code, the information on the character region, and the reliability of the recognition result are obtained.

In S409, the replacement unit 206 replaces the character obtained from the text line region subjected to the character re-recognition in S408 out of the character group obtained as a result of the character recognition processing on the entire document image in S402 with the character obtained as a result of the character re-recognition in S408. For example, the replacement unit 206 determines whether to replace the result of the character recognition processing in S402 with the result of the character re-recognition in S408 (replacement determination). Then, if it is determined to replace the character, the replacement unit 206 may replace the character obtained as a result of S402 with the character obtained as a result of the character re-recognition in S408. As a result of the processing in S409, a definitive character recognition result is obtained as the information on the character included in the document image. Then, as a character recognition result of the document image, the output unit 207 outputs the information on the character group obtained as a result of the character recognition processing on the entire document image in S402 after the replacement by the replacement unit 206.

The method of the replacement determination may be a method in which it is determined to replace the character in a case where the reliability of the character obtained as a result of the character re-recognition in S408 is higher than the reliability of the character obtained as a result of the character recognition processing in S402. Additionally, it may be a method in which the character to be the replacement target is determined in advance, and the character is replaced in a case where there is the character to be the replacement target in a result of the character re-recognition performed. Moreover, in the determination of the replacement target character, it may be determined whether to replace the character obtained as a result of the character recognition from the text line region that is the character re-recognition target by using a ratio of the included replacement target characters.

### Character Attribute Determination Processing

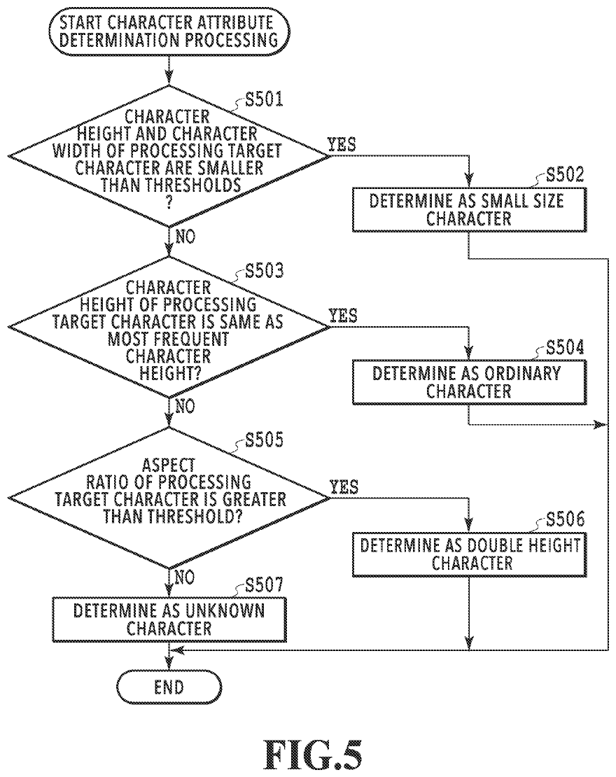

FIG. 5 is a flowchart describing details of the character attribute determination processing. The processing in S404 is described with reference to the flowchart in FIG. 5.

In the character attribute determination processing, one processing target character is selected from the characters obtained as a result of the character recognition processing in S402, and the character attribute is determined for the processing target character. The flowchart in FIG. 5 is a diagram describing the processing to determine the character attribute for the selected processing target character. In S404, until the character attributes of all the characters obtained as a result of the character recognition processing in S402 are determined, the processing target character is selected, and the processing in the flowchart in FIG. 5 to determine the character attribute of the processing target character is performed repeatedly.

In S501, the character attribute determination unit 203 determines whether the character height of the processing target character is smaller than a character height threshold, and the character width of the processing target character is smaller than a character width threshold. If it is determined that both the character height and character width are smaller than the thresholds (YES in S501), the process transitions to S502. In S502, the character attribute determination unit 203 determines that the character attribute of the processing target character is a “small size character” and ends the character attribute determination processing on the processing target character.

If it is determined that either one of the character height and the character width of the processing target character is equal to or greater than the thresholds (NO in S501), the process transitions to S503.

In S503, the character attribute determination unit 203 determines whether the character height of the processing target character is the same as the most frequent character height obtained in S403. In a case where a difference between the most frequent character height and the character height of the processing target character is within a predetermined value, it may be determined as the same. If it is determined that the character height of the processing target character is the same as the most frequent character height (YES in S503), the process transitions to S504. In S504, the character attribute determination unit 203 determines that the character attribute of the processing target character is the “ordinary character” and ends the character attribute determination processing. The character with the character attribute of the “ordinary character” may be simply described as the ordinary character.

The ordinary character is a character attribute of the character that the character recognition unit 202 can properly character-recognize. For the characters in the document, characters of common fonts such as Gothic and Mincho are usually used, and the character recognition unit 202 is constructed so as to be able to properly character-recognize the characters of those fonts. The characters of those fonts usually have basically the same character heights even for one-byte and two-byte characters and vertically long characters such as “1” and “1”. For this reason, in a case where the character height of the processing target character is the same as the most frequent character height, it is possible to determine that it is the “ordinary character”, which is the character attribute proper for the character recognition processing.

If it is determined that the character height of the processing target character is not the same as the most frequent character height (NO in S503), the process transitions to S505.

In S505, the character attribute determination unit 203 determines whether the aspect ratio (a ratio of the character height with respect to the character width) of the processing target character is greater than a threshold. If the ratio of the character length with respect to the character width of the processing target character is greater than the threshold (YES in S505), the process transitions to S506. In S506, the character attribute determination unit 203 determines that the character attribute of the processing target character is the “double height character” and ends the character attribute determination processing. The character with the character attribute of the “double height character” may be described as the double height character.

If the ratio of the character height with respect to the character width of the processing target character is smaller than the threshold (NO in S505), the process transitions to S507. In S507, the character attribute determination unit 203 determines that the character attribute of the processing target character as an “unknown character” and ends the character attribute determination processing. The character with the character attribute of the “unknown character” may be described as the unknown character.

The threshold used in each determination in the character attribute determination processing is determined based on the most frequent character height obtained in S403. Alternatively, the threshold may be calculated based on the most frequent character width or may be a value determined in advance.

### Text Line Attribute Determination Processing

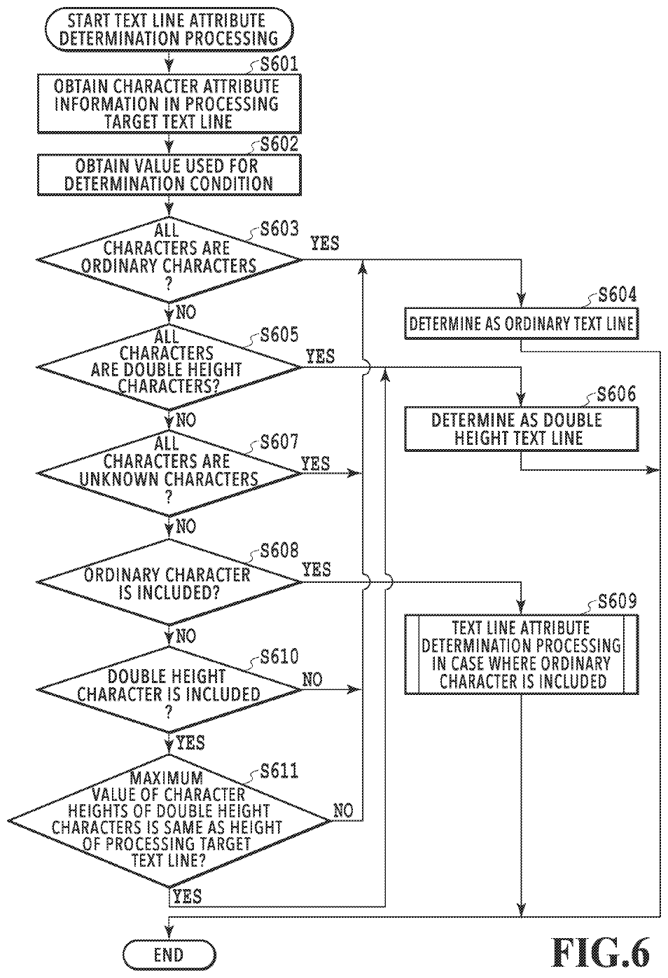

FIG. 6 is a flowchart describing details of the text line attribute determination processing. The processing in S406 is described with reference to the flowchart in FIG. 6. In the text line attribute determination processing, one processing target text line region is selected from the text line regions identified in S405, and the text line attribute for the processing target text line region is determined. The flowchart in FIG. 6 is a diagram describing the processing to determine the text line attribute for the selected processing target text line region. In S406, until the text line attributes of all the text line regions identified in S405 are determined, the processing target text line region is selected, and the processing in the flowchart in FIG. 6 to determine the text line attribute of the processing target text line region is performed repeatedly.

In S601, the text line attribute determination unit 204 obtains the information on the character attribute of the character included in the processing target text line region.

In S602, the text line attribute determination unit 204 obtains a value to be used to determine the text line attribute. For example, the maximum value of the character height for each character attribute of the character included in the processing target text line region and a threshold determined in advance are obtained.

In S603, the text line attribute determination unit 204 determines whether all the characters in the processing target text line region are the ordinary characters. If it is determined that all the characters in the processing target text line region are the ordinary characters (YES in S603), the process transitions to S604. In S604, the text line attribute determination unit 204 determines that the text line attribute of the processing target text line region is an “ordinary text line” and ends the text line attribute determination processing on the processing target text line region.

If it is determined that all the characters in the processing target text line region are not the ordinary characters (NO in S603), the process transitions to S605. In S605, the text line attribute determination unit 204 determines whether all the characters included in the processing target text line region are the double height characters.

If it is determined that all the characters in the processing target text line region are the double height characters (YES in S605), the process transitions to S606. In S606, the text line attribute determination unit 204 determines that the text line attribute of the processing target text line region is a “double height text line” and ends the text line attribute determination processing.

If it is determined that all the characters in the processing target text line region are not the double height characters (NO in S605), the process transitions to S607. In S607, the text line attribute determination unit 204 determines whether all the characters included in the processing target text line region are the unknown characters. If it is determined that all the characters in the processing target text line region are the unknown characters (YES in S607), the process transitions to S604. Then, the text line attribute determination unit 204 determines that the text line attribute of the processing target text line region is the “ordinary text line” and ends the text line attribute determination processing.

If it is determined that all the characters in the processing target text line region are not the unknown characters (NO in S607), the process transitions to S608. In S608, the text line attribute determination unit 204 determines whether at least one ordinary character is included in the processing target text line region.

If it is determined that the ordinary character is included in the processing target text line region (YES in S608), the process transitions to S609. In S609, the text line attribute determination unit 204 determines either one of a “character size-mixed text line”, the “double height text line”, and the “ordinary text line” as the text line attribute of the processing target text line region and ends the processing. Details of the processing in S609 are described later.

If it is determined that no ordinary character is included in the processing target text line region (NO in S608), the process transitions to S610. In S610, the text line attribute determination unit 204 determines whether the double height character is included in the processing target text line region. If it is determined that no double height character is included (NO in S610), the process transitions to S604, and the text line attribute determination unit 204 determines that the text line attribute of the processing target text line region is the “ordinary text line” and ends the text line attribute determination processing.

If it is determined that the double height character is included (YES in S610), the process transitions to S611. In S611, the text line attribute determination unit 204 determines whether the height of the processing target text line region and the maximum value of the character heights of the double height characters included in the text line region are the same. In a case where a difference between the height of the processing target text line region and the maximum value of the character heights of the double height characters is within a predetermined value, it can be determined as the same.

If it is determined that the height of the processing target text line region and the maximum value of the character heights of the double height characters included in the text line region are the same (YES in S611), the process transitions to S606, and the text line attribute determination unit 204 determines that the text line attribute of the processing target text line region is the “double height text line” and ends the text line attribute determination processing.

The transition to S611 suggests the possibility that the small size character, the unknown character, and the double height character are included in the processing target text line region. In the receipt and the like, there are many cases in which a character string of a high importance such as the total price is printed large with the double height character. Accordingly, in a case where the character height of the double height character is the same as the height of the text line region, it is considered that the double height character is a character of high priority to be recognized from the characters in the text line region. If it is determined that the text line attribute is the “double height text line”, this text line region is subjected to the deformation processing in S407 such that the double height character is properly character-recognized. Therefore, if it is determined as YES in S611, the text line attribute is determined as the “double height text line”.

On the other hand, if it is determined that the height of the processing target text line region and the maximum value of the character heights of the double height characters included in the text line region are not the same (NO in S611), the process transitions to S604. Then, the text line attribute determination unit 204 determines that the text line attribute of the processing target text line region is the “ordinary text line” and ends the text line attribute determination processing.

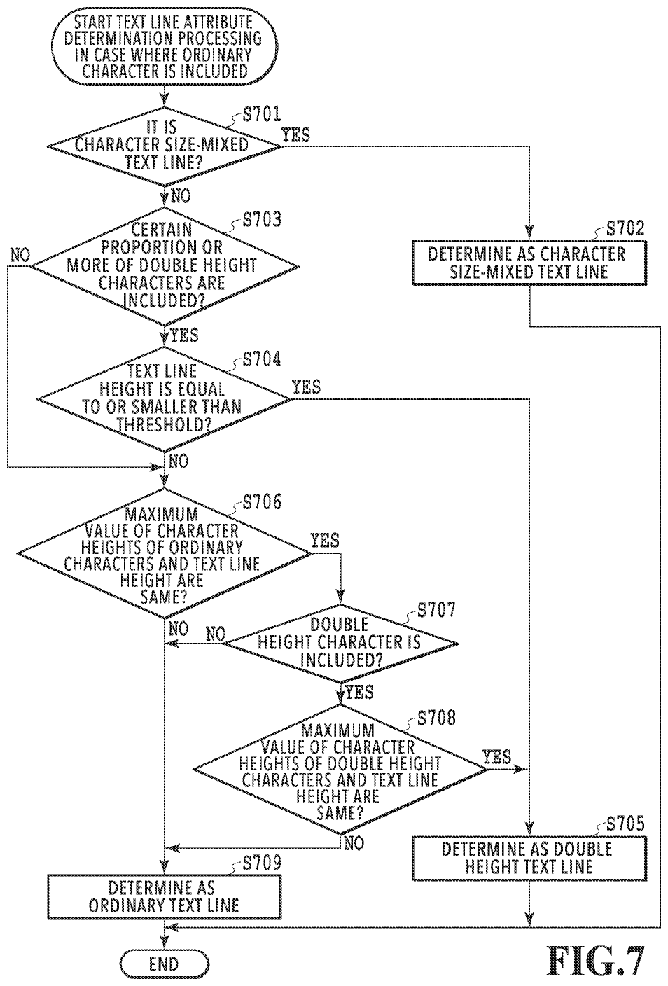

FIG. 7 is a flowchart describing the details of the processing in S609. The details of the processing in S609 are described with reference to FIG. 7.

In S701, the text line attribute determination unit 204 determines whether the text line attribute of the processing target text line region is the character size-mixed text line. The character size-mixed text line represents a text line in which characters of different character sizes (a small character and a large character) are mixed. In the determination in S701, the ordinary character is the small character. Additionally, in the determination in S701, the large character is an example of the special character and is a character with a greater character height than a character threshold. The character threshold may be a value determined in advance, may be set based on the most frequent character height obtained in S403, or may be set based on the most frequent character width.

In S701, in a case where the processing target text line region satisfies all the following conditions, the text line attribute determination unit 204 determines that the text line attribute is the “character size-mixed text line”.
(1) The small character and the large character are included, and the character types are determined in advance.
(2) A difference between lower ends of the small character and the large character is equal to or smaller than a first threshold.
(3) A difference between upper ends of the small character and the large character is equal to or greater than a second threshold.
(4) A ratio between a height of the small character and a height of the large character is equal to or smaller than a third threshold.

The character type used in the above-described (1) is determined for each of the small character and the large character empirically. The character type of the small character is, for example, a character such as “year”, “month”, and “day”, a two-byte character, or the like. The character type of the large character is, for example, a number such as “1”, “2”, and “3”, a one-byte character, or the like. Additionally, as the thresholds of the differences between the upper ends and the lower ends of the small character and the large character, the most frequent values or average values of the upper ends and the lower ends of each of the small characters and the large characters in the processing target text line region are used. (4) is provided so as not to determine as the character size-mixed text line in a case where the difference between the character height of the small character and the character height of the large character is too great.

If it is determined that the text line attribute of the processing target text line region is the character size-mixed text line (YES in S701), the process transitions to S702. In S702, the text line attribute determination unit 204 determines that the text line attribute of the processing target text line region is the “character size-mixed text line” and ends the text line attribute determination processing on the processing target text line region.

If it is not determined that the text line attribute of the processing target text line region is the character size-mixed text line (NO in S701), the process transitions to S703. In S703, the text line attribute determination unit 204 determines whether the proportion of the double height characters in the characters in the processing target text line region is equal to or greater than a certain proportion. The certain proportion is 60 percent, for example. If the proportion of the double height characters in the processing target text line region is equal to or greater than the certain proportion (YES in S703), the process transitions to S704.

In S704, the text line attribute determination unit 204 determines whether a text line height of the processing target text line region is equal to or smaller than a text line height threshold. The text line height threshold is a threshold used to determine a height of the text line region. If the text line height of the processing target text line region is equal to or smaller than the text line height threshold (YES in S704), the process transitions to S705, and the text line attribute determination unit 204 determines that the text line attribute of the processing target text line region is the “double height text line” and ends the text line attribute determination processing.

On the other hand, if it is determined that the proportion of the double height characters in the processing target text line region is smaller than the certain proportion (NO in S703), or if the text line height of the processing target text line region exceeds the text line height threshold (NO in S704), the process transitions to S706.

In S706, the text line attribute determination unit 204 determines whether the maximum value of the character heights of the ordinary characters included in the processing target text line region and the height of the processing target text line region are the same. In a case where a difference between the height of the processing target text line region and the maximum value of the character heights of the ordinary characters included in the text line region is within a predetermined value, it can be determined as the same.

If it is determined that the maximum value of the character heights of the ordinary characters included in the processing target text line region and the text line height are the same (YES in S706), the process proceeds to S707. In S707, the text line attribute determination unit 204 determines whether the double height character is included in the processing target text line region. If it is determined in S707 that the double height character is included (YES in S707), the process transitions to S708. In S708, the text line attribute determination unit 204 determines whether the height of the processing target text line region and the maximum value of the character heights of the double height characters included in the text line region are the same. In a case where a difference between the height of the processing target text line region and the maximum value of the character heights of the double height characters is within a predetermined value, it can be determined as the same.

If it is determined that the height of the processing target text line region and the maximum value of the character heights of the double height characters included in the text line region are the same (YES in S708), the process transitions to S705. In S705, the text line attribute determination unit 204 determines that the text line attribute of the processing target text line region is the “double height text line” and ends the text line attribute determination processing. As described above, in the receipt and the like, there are many cases in which a character string of a high importance such as the total price is printed large with the double height character. Accordingly, in a case where the maximum value of the character heights of the ordinary characters included in the text line region and the maximum value of the character heights of the double height characters included in the text line region are the same as the text line height, the text line attribute is determined as the “double height text line”.

On the other hand, if it is determined that the character height of the ordinary character is not the same as the text line height in the processing target text line region (NO in S706), or if it is determined that no double height character is included in the processing target text line region (NO in S707), the process transitions to S709. Additionally, if it is determined that the height of the processing target text line region and the maximum value of the character heights of the double height characters included in the text line region are not the same (NO in S708), the process transitions to S709.

The transition to S709 means that none of the conditions of the “character size-mixed text line” and the “double height text line” are satisfied in the past steps. In this case, the text line attribute determination unit 204 determines that the text line attribute of the processing target text line region is the “ordinary text line” and ends the text line attribute determination processing.

### About Generation of Character Re-Recognition Target Text Line Image

Subsequently, the deformation processing of the text line region to be the character re-recognition target in S407 in FIG. 4 is described. In S408, which is the next step after S407, the character re-recognition is performed on the text line region that is the target region in which there is the possibility that the character is falsely recognized. Therefore, in S407, the deformation unit 205 performs processing to enlarge the text line region with the target text line attribute such that the character in the text line region has a shape of the character appropriate for the character recognition processing. In the present embodiment, the target text line region on which the character re-recognition needs to be performed is a text line region of the double height text line or the character size-mixed text line that is the text line region including the special character that is likely to be falsely recognized.

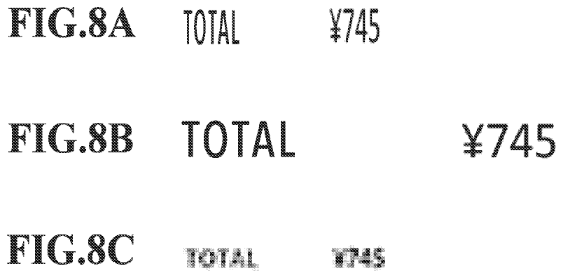

FIGS. 8A through 8C are diagrams describing the deformation of the text line region with the text line attribute of the double height text line. FIG. 8A is an image extracted from the text line 302 in FIG. 3 and represents an example of the text line region with the text line attribute of the double height text line. In a case where the processing target text line attribute is the double height text line, the deformation unit 205 deforms the text line region to be enlarged in only the transverse direction such that the height-width ratio of the character in the text line region is equal to the height-width ratio of the ordinary character. For example, deformation to enlarge twofold in only the transverse direction is performed. FIG. 8B illustrates an example of an image after FIG. 8A is enlarged twofold in the transverse direction.

FIG. 8C is a diagram describing a comparative example of the deformation processing in S407. For example, as the deformation processing, it may also be considered to reduce the text line height of the double height text line by half so as to be equal to the size of the ordinary character. FIG. 8C is a diagram of a case where the text line region in FIG. 8A is reduced. With the reduction as illustrated in FIG. 8C, for example, the character is worn out if there is included a character such as a kanji with many strokes or a thick character, and the character recognition may be difficult even though the deformation is performed.

On the other hand, in the present embodiment, regardless of the size of the ordinary character, that is, the most frequent value of the character size in the document image, the deformation unit 205 in S407 performs the processing to enlarge the text line region of the double height text line in the transverse direction. Thus, the deformation to make the height-width ratio of the double height character of the text line region equal to the height-width ratio of the ordinary character is performed. Therefore, in the method of the present embodiment, it is possible to obtain an image of a character appropriate for the character recognition by the character recognition unit 202 without damaging the information on the character as a result of the deformation processing.

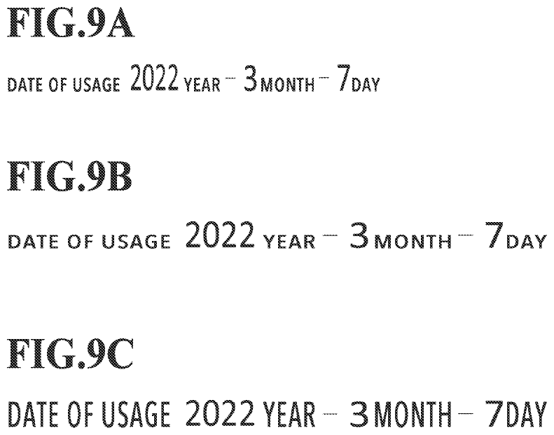

FIGS. 9A through 9C are diagrams describing the deformation of the text line region that is executed in S407 in a case where the text line attribute determined in S406 is the character size-mixed text line. FIG. 9A is an image of the text line region extracted from a text line 303 in FIG. 3, and the text line 303 is an example of the text line region with the text line attribute of the character size-mixed text line.

In a case where the text line attribute of the processing target text line region is the character size-mixed text line, first, the deformation unit 205 enlarges the entire processing target text line region in the transverse direction. For example, an enlargement ratio is a value obtained by dividing the height of the processing target text line region (the character height of the large character) by the character height of the small character (the ordinary character) in the text line region. Alternatively, the enlargement ratio may be a constant value determined in advance. FIG. 9B is an image of the text line region obtained by enlarging the processing target text line region in FIG. 9A in only the transverse direction.

Next, the deformation unit 205 extracts a partial image of the small character (the ordinary character) out of the characters included in the text line region enlarged in the transverse direction and enlarges the extracted partial image in the longitudinal direction by the enlargement ratio similar to that in the enlargement in the transverse direction. Then, the partial image of the small character (the ordinary character) enlarged in the longitudinal direction is synthesized with the text line region so as to be replaced with the small character in the text line region enlarged in the transverse direction. FIG. 9C illustrates an example of an image obtained by synthesizing the partial image obtained by enlarging the small character (the ordinary character) in the longitudinal direction with the text line image in FIG. 9B. As a result, an image of the text line region in which the small character (the ordinary character) is enlarged by the same enlargement ratio in the longitudinal direction and the transverse direction, and the large character is enlarged in only the transverse direction is obtained. For the text line region with the text line attribute of the character size-mixed text line, an image of the text line region for the character re-recognition is generated.

In a case where the character recognition is performed on the entire document image, there is the possibility that the special character such as the double height character is not properly character-recognized, and the character is falsely recognized. On the other hand, in the present embodiment, in order to prevent the false recognition and outputting of the special character such as the double height character, the text line region is enlarged to adjust the aspect ratio of the special character. Then, with the character re-recognition performed on the image of the text line region after the enlargement, the character is re-recognized from the image including the special character. Therefore, it is possible to suppress the outputting, as a character recognition result, of the character obtained as a result of the false recognition of the special character that is difficult to recognize. Additionally, it is possible to suppress the damage of the character information due to the deformation of the image.

Note that, in some cases, a double width character that is a character having a longer character width than the ordinary character may be included in the document image. For the double width character, deformation to enlarge only in the longitudinal direction may be performed.

Additionally, in the present embodiment, it is described that the text line region is identified, and the enlargement processing is performed in the unit of text line region in accordance with the attribute of the text line region. Moreover, the region as the enlargement processing target may be a region including one character of the special characters such as the double height character or may be a region including only a character string of the special characters.

### Second Embodiment

In the first embodiment, the method of suppressing the outputting of the falsely recognized character by enlarging the text line region that is the character re-recognition target is described. In the present embodiment, a method of suppressing the false recognition of the character that can occur due to the enlargement of the text line region is described. In the present embodiment, a difference from the first embodiment is mainly described. The same configuration and processing as that of the first embodiment are applied unless otherwise stated.

In the character recognition on the enlarged image, in some cases, the false recognition of the character may be more likely to occur than a case of the character recognition on the image that is not enlarged. For example, assuming that an image of a vertically long character like “l (ell)” is enlarged twofold in only the transverse direction. Then, if the character re-recognition is performed on the image of “1 (ell)” after the enlargement, it may be falsely recognized as a character of “1 (one)”. Likewise, if the image of “1 (one)” is enlarged twofold in the transverse direction, and the character re-recognition is performed on the image of “1 (one)” after the enlargement, it may be falsely recognized as “7 (seven)”.

To deal with this, in the present embodiment, a character that is likely to be falsely recognized due to the enlargement of the character in the transverse direction is identified in advance, and a low recognition rate character list holding the character that is likely to be falsely recognized is generated in advance and saved in the HDD 114. For example, the low recognition rate character list includes the characters of “1 (ell)” and “1 (one)” that are the characters likely to be falsely recognized due to the enlargement (low recognition rate characters).

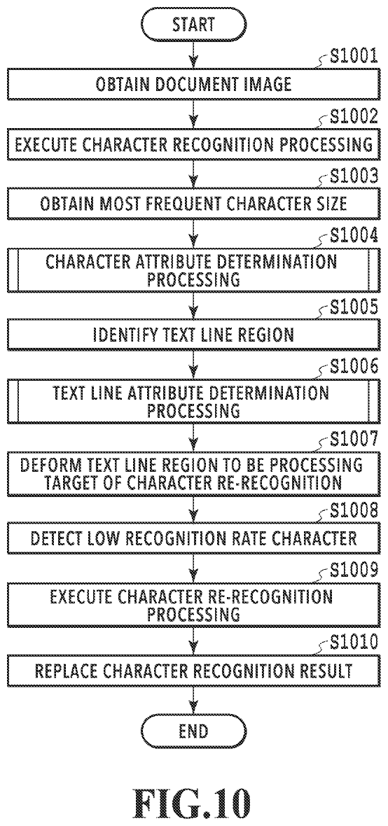

FIG. 10 is a flowchart describing a flow of the OCR processing in the present embodiment. S1001 to S1007 are similar to S401 to S407; for this reason, detailed description is omitted. After the processing to enlarge the text line region that is the character re-recognition target in S1007, the process transitions to S1008.

In S1008, from the character group obtained by the character recognition on the entire document image in S1002, the replacement unit 206 detects a character that matches the low recognition rate character held in the low recognition rate character list. If the character that matches the low recognition rate character included in the low recognition rate character list is detected, the replacement unit 206 saves the character information on the detected character into the RAM 113 as information on the character that is an exception to the replacement. Alternatively, the replacement unit 206 may label the character that is from the character group obtained as a result of the character recognition in S1002 and matches the low recognition rate character to indicate that it is the exception to the replacement. With the labeling, it is possible to set the character group obtained as a result of the character recognition in S1002 to be able to be identified into the replacement target character and the character exception to the replacement.

In S1009, the character recognition unit 202 performs the character re-recognition on the enlarged text line region. Unlike S408, in a case where there is the character that matches the low recognition rate character in the enlarged text line region, the character recognition unit 202 does not perform the character re-recognition on the region of the character.

In S1010, the replacement unit 206 replaces the corresponding character from the character group obtained as a result of the character recognition processing in S1002 with the character obtained as a result of the processing of the character re-recognition in S1009.

For example, assuming a case where a document image including the character of “1” is obtained in S1001, and after the character recognition performed on the entire document image in S1002, the character of “1” is obtained as a result of proper recognition of the character of “1”. Additionally, assuming that the text line region including the character of “1” is determined as the double height text line in S1006, and the text line region is enlarged twofold in the transverse direction in S1007. In a case where “1” is held in the low recognition rate character list, in S1008, “1” of the double height text line is set as the exception to the replacement. In this case, in S1009, the character re-recognition is performed on a region other than the region of “1” in the enlarged double height text line. Then, in the replacement processing in S1010, the character of the double height text line from the character group obtained as a result of the character recognition performed on the entire document image in S1002 is replaced with the character obtained as a result of the character re-recognition in S1009. In this process, since the character re-recognition is not performed on the character of “1” that is from the characters included in the double height text line but set as the exception to the replacement, the processing is performed so as not to replace “1” with the character obtained as a result of the character recognition processing in S1002.

As described above, according to the present embodiment, it is possible to suppress the outputting of a character different from the original character as a result of recognizing the low recognition rate character. Therefore, it is possible to improve the accuracy of the character recognition in the document image. Additionally, since the number of the characters to be the target of the character re-recognition and the replacement in the double height text line can be reduced, it is possible to implement the improvement in the processing speed.

Note that, in a case where the processing to make the height-width ratio of the double height character equal to that of the ordinary character by reducing the double height text line in the longitudinal direction, a low recognition rate character list holding a character that is likely to be falsely recognized due to the reduction of the character may be generated in advance and may be saved in the HDD 114.

Additionally, in some cases, the double width character that is a character having a longer character width than the ordinary character may be included in the document image. In some cases, for the double width character, processing to make the height-width ratio equal to that of the ordinary character by the deformation to enlarge in the longitudinal direction or by the deformation to reduce in the transverse direction may be performed. In this case, likewise, a low recognition rate character list holding a character that is likely to be falsely recognized due to the deformation may be generated in advance and may be saved in the HDD 114.

According to the technique of the present disclosure, it is possible to improve the accuracy of the character recognition of the special character included in the document image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-000179 filed, Jan. 4, 2023, which is hereby incorporated by reference wherein in its entirety.

What is claimed is:

1. An image processing apparatus, comprising:
an obtainment unit configured to obtain a document image at least including first character images and second character images, the first character images being ordinary character images appropriate for character recognition processing, the second character images having a different height-width ratio from a height-width ratio of the ordinary character images and having a greater size than a size of the ordinary character images;
an enlargement unit configured to enlarge a target text line region including the second character images such that the height-width ratio of each of the second character images included in the target text line region is equal to the height-width ratio of the first character images; and
a character recognition unit configured to perform character recognition processing on the target text line region enlarged by the enlargement unit.

2. The image processing apparatus according to claim 1, further comprising:
a replacement unit configured to replace a first character recognition results obtained by performing the character recognition processing on the target text line region of the document image with a second character recognition results obtained by the character recognition unit performing the character recognition processing on the target text line region enlarged by the enlargement unit.

3. The image processing apparatus according to claim 2, wherein
in a case where a reliability of the second character recognition results is higher than a reliability of the first character recognition results, the replacement unit replaces the first character recognition results with the second character recognition results.

4. The image processing apparatus according to claim 2, wherein
in a case where the first character image is a predetermined character, the character recognition unit does not perform the character recognition processing on the first character image in the target text line region enlarged by the enlargement unit.

5. The image processing apparatus according to claim 4, wherein
in a case where the first character image is the predetermined character, the replacement unit does not replace the first character.

6. The image processing apparatus according to claim 4, wherein
the predetermined character is a character that has a possibility that the character recognition unit falsely recognizes in a case of being enlarged.

7. The image processing apparatus according to claim 4, wherein
whether the first character image is the predetermined character is determined based on a list holding the predetermined character.

8. The image processing apparatus according to claim 2, further comprising:
an output unit configured to output the character recognition results after the replacement is performed by the replacement unit as information on the second character images a character in the document image.

9. The image processing apparatus according to claim 1, further comprising:
a text line attribute determination unit configured to identify a text line region in the document image and to determine a text line attribute of the text line region based on a character attribute of a character included in the text line region, wherein
the enlargement unit enlarges the target text line region having a predetermined text line attribute that includes the second character images.

10. The image processing apparatus according to claim 9, wherein
the text line attribute determination unit determines an attribute of a text line region that includes the both of first character images and the second character images as a character size-mixed text line that is one of the predetermined text line attributes, and
the enlargement unit enlarges the text line region of the character size-mixed text line such that the first character images are enlarged in a longitudinal direction and a transverse direction, and the second character images are enlarged in only the transverse direction.

11. The image processing apparatus according to claim 1, further comprising:
an attribute determination unit configured to obtain the most frequent character height and the most frequent character width of a character image included in the document image and to determine a character attribute of the character image based on at least either one of the most frequent character height and the most frequent character width, wherein
the character attribute includes attributes of the first character images and the second character images.

12. The image processing apparatus according to claim 11, wherein
the second character images are double height characters, and
the attribute determination unit determines that a character having a different character height from the most frequent character height and a ratio of a character height with respect to a character width greater than a threshold is the double height character.

13. The image processing apparatus according to claim 11, wherein
the attribute determination unit determines that character images having the same character height as the most frequent character height are the first character images.

14. The image processing apparatus according to claim 13, wherein
being the same includes a case where a difference from the most frequent character height is within a predetermined value.

15. The image processing apparatus according to claim 1, wherein
the second character images are double height characters, and
the enlargement unit enlarges the target text line region in only a transverse direction.

16. The image processing apparatus according to claim 1, wherein
the document image is an image obtained by scanning a receipt.

17. An image processing method, comprising:
obtaining a document image at least including first character images and second character images, the first character images being ordinary character images appropriate for character recognition processing, the second character images having a different height-width ratio from a height-width ratio of the ordinary character images and having a greater size than a size of the ordinary character images;
enlarging a target text line region including the second character images such that the height-width ratio of each of the second character images included in the target text line region is equal to the height-width ratio of the first character images; and
performing character recognition processing on the enlarged target text line region.

18. A non-transitory computer readable storage medium storing a program which causes a computer to perform an image processing method, the image processing method comprising:
obtaining a document image at least including first character images and second character images, the first character images being ordinary character images appropriate for character recognition processing, the second character images having a different height-width ratio from a height-width ratio of the ordinary character images and having a greater size than a size of the ordinary character images;
enlarging a target text line region including the second character images such that the height-width ratio of each of the second character images included in the target text line region is equal to the height-width ratio of the first character images; and
performing character recognition processing on the enlarged target text line region.
